(19) United States
(12) Patent Application Publication
(10) Pub. No.: US 2026/0224992 A1
(43) Pub. Date: Aug. 6, 2026

(54) GRAPHICAL USER INTERFACE PROCESSING METHOD, COMPUTER STORAGE MEDIUM, AND ELECTRONIC DEVICE

(71) Applicant: NETEASE (HANGZHOU) NETWORK CO., LTD., Hangzhou, Zhejiang (CN)

(72) Inventors: Zeting LONG, Guangzhou, Guangdong (CN); Yu PENG, Guangzhou, Guangdong (CN)

(73) Assignee: NETEASE (HANGZHOU) NETWORK CO., LTD., Hangzhou, Zhejiang (CN)

(21) Appl. No.: 19/142,309

(22) PCT Filed: May 23, 2023
(86) PCT No.: PCT/CN2023/095885

§ 371 Date: Jun. 23, 2025

(30) Foreign Application Priority Data
Dec. 23, 2022 (CN) 202211669556.0

(51) Int. Cl. A63F 13/58; A63F 13/533; A63F 13/837

(52) U.S. Cl. CPC A63F 13/58; A63F 13/533; A63F 13/837

(57) ABSTRACT

A method for game skill processing includes: in response to a moving control instruction on the controlled virtual object, controlling the controlled virtual object to move within the game scene; in response to the controlled virtual object and the container object being within an initial interaction range determined based on the initial interaction parameter, controlling to display interaction prompt information of the container object; in response to a first interaction operation performed by the controlled virtual object in the game match interface, controlling an adjustment of the initial interaction parameter to a current interaction parameter; and in response to the controlled virtual object and the container object being within a current interaction range determined based on the current interaction parameter, controlling to display the interaction prompt information of the container object, where the current interaction range is larger than the initial interaction range.

### CROSS REFERENCE TO RELATED APPLICATION

The present disclosure claims the priority of the Chinese Patent Application No. 202211669556.0, titled “GAME SKILL PROCESSING METHOD AND APPARATUS, A COMPUTER STORAGE MEDIUM, AND AN ELECTRONIC DEVICE”, filed on Dec. 23, 2022, which is incorporated herein by reference in its entirety.

### TECHNICAL FIELD

Embodiments of the present disclosure relate to the field of computer technologies, specifically to a game skill processing method and apparatus, a computer-readable storage medium, and an electronic device.

### BACKGROUND

With the development of technology, various types of games have emerged. Especially in military-themed games, due to the simulation of military battlefields, an increasing number of players are attracted.

In large-scale multiplayer military-themed games, a looting skill of a controlled virtual object, as part of character development, also affects game balance of players in the game. In related technologies, when a virtual object is defeated, the looting skill can be used to loot the defeated virtual object.

During the looting process, an interaction range between the controlled virtual object and the defeated virtual object remains unchanged, resulting in a poor user experience in the game.

Therefore, a new game skill processing method is needed.

It should be noted that the information disclosed in the above background section is only used to enhance the understanding of the background of the present disclosure and may include information that does not constitute prior art known to those of ordinary skill in the art.

### SUMMARY

The present disclosure provides a game interaction method and apparatus, a storage medium and an electronic device, thereby enhancing the diversity and richness of game interaction forms.

The present disclosure is directed to provide a game skill processing method, a game skill processing apparatus, a computer-readable storage medium and an electronic device, thereby at least to some extent overcoming the problem of poor user game experience caused by the limitations and defects of related technologies.

According to one aspect of the present disclosure, a method for game skill processing is provided, including:
in response to a moving control instruction on the controlled virtual object, controlling the controlled virtual object to move within the game scene, wherein the controlled virtual object is configured with a target game skill, and the target game skill is configured with an initial interaction parameter;
in response to the controlled virtual object and the container object being within an initial interaction range determined based on the initial interaction parameter, controlling to determine receiving of an interaction instruction corresponding to the container object, and controlling to display interaction prompt information of the container object or triggering execution of an interaction behavior for acquiring information of a contained object comprised in the container object;
in response to a first interaction operation performed by the controlled virtual object in the game match interface, controlling an adjustment of the initial interaction parameter to a current interaction parameter; and
in response to the controlled virtual object and the container object being within a current interaction range determined based on the current interaction parameter, controlling to determine receiving of the interaction instruction corresponding to the container object, and controlling to display the interaction prompt information of the container object or triggering execution of the interaction behavior for acquiring the information of the contained object comprised in the container object, wherein the current interaction range is larger than the initial interaction range.

According to one aspect of the present disclosure, a game skill processing apparatus is provided, including:
a controlled virtual object movement module configured to, in response to a moving control instruction on the controlled virtual object, control the controlled virtual object to move within the game scene, wherein the controlled virtual object is configured with a target game skill, the target game skill is configured with an initial interaction parameter;
a first interaction module configured to, in response to the controlled virtual object and the container object being within an initial interaction range determined based on the initial interaction parameter, control to determine receiving of an interaction instruction corresponding to the container object, and control to display interaction prompt information of the container object or trigger execution of an interaction behavior for acquiring information of a contained object comprised in the container object;
a skill adjustment module configured to, in response to a first interaction operation performed by the controlled virtual object in the game match interface, control an adjustment of the initial interaction parameter to a current interaction parameter; and
a second interaction module configured to, in response to the controlled virtual object and the container object being within a current interaction range determined based on the current interaction parameter, control to determine receiving of the interaction instruction corresponding to the container object, and control to display the interaction prompt information of the container object or trigger execution of the interaction behavior receiving the information of the contained object comprised in the container object, wherein the current interaction range is larger than the initial interaction range.

According to one aspect of the present disclosure, a computer storage medium storing a computer program is provided, where the computer program, upon being executed by a processing unit, is used for implementing the method for game skill processing according to any of the foregoing exemplary embodiments.

According to one aspect of the present disclosure, an electronic device is provided, including:
a processing unit; and
a storage unit configured to store an executable instruction of the processing unit;
where the processing unit is configured to implement, by executing the executable instruction, the method for game skill processing according to any of the foregoing exemplary embodiments.

In the method for game skill processing according to some embodiments of the present disclosure, in response to the moving control instruction on the controlled virtual object, the controlled virtual object is controlled to move within the game scene, where the controlled virtual object is configured with the target game skill, and the target game skill is configured with the initial interaction parameter; in response to the controlled virtual object and the container object being within the initial interaction range determined based on the initial interaction parameter, the reception of the interaction instruction corresponding to the container object is controlled to be determined, the interaction prompt information of the container object is controlled to be displayed or the execution of the interaction behavior to acquire the information of the contained object included in the container object is triggered; in response to the first interaction operation performed by the controlled virtual object in the game match interface, the initial interaction parameter is controlled to be adjusted to the current interaction parameter; and in response to the controlled virtual object and the container object being within the current interaction range determined based on the current interaction parameter, the reception of the interaction instruction corresponding to the container object is controlled to be determined, the interaction prompt information of the container object is controlled to be displayed or the execution of the interaction behavior to acquire the information of the contained object included in the container object is triggered, where the current interaction range is larger than the initial interaction range. On the one hand, in response to the first interaction operation performed by the controlled virtual object in the game match interface, the initial interaction parameter is controlled to be adjusted to the current interaction parameter; the problem in the related technology that the interaction range between the controlled virtual object and the defeated virtual object remains unchanged is solved, the optimization of the targeted game skill has been achieved, and the interaction experience of the player in the game is enhanced. On the other hand, after the initial interaction parameter is adjusted to the current interaction parameter, in response to the current interaction range between the controlled virtual object and the container object determined based on the current interaction parameter, the interaction prompt information of the container object is controlled to be displayed or the execution of the interaction behavior to acquire the information of the contained object included in the container object is triggered based on the current interaction range; the optimization efficiency of the target game skill in the game is improved.

It should be understood that the above general description and the detailed description to follow are merely exemplary and explanatory and are not intended to limit the present disclosure.

### BRIEF DESCRIPTION OF DRAWINGS

The drawings incorporated herein form a part of the specification and illustrate embodiments of the present disclosure, and together with the specification, serve to explain the principles of the present disclosure. It can be understood that the drawings in the following description are only some embodiments of the present disclosure. For ordinary skilled in this art, other drawings can be obtained according to these drawings without creative work.

FIG. 1 schematically illustrates a flowchart of a method for game skill processing according to an exemplary embodiment of the present disclosure.

FIG. 2 schematically illustrates a flowchart of a method for determining an initial interaction range based on an initial interaction parameter according to an exemplary embodiment.

FIG. 3 schematically illustrates a flowchart of a method for controlling to display interaction prompt information of a container object or triggering an execution of an interaction behavior to acquire information of the contained object included in the container object according to an exemplary embodiment.

FIG. 4 schematically illustrates a schematic diagram of a controlled virtual object being within a game scene according to an exemplary embodiment.

FIG. 5 schematically illustrates a schematic diagram of the controlled virtual object and the container object being within a first interaction range according to an exemplary embodiment.

FIG. 6 schematically illustrates a schematic diagram showing an expansion of the first interaction range as a level of the target game skill of the controlled virtual object increases according to an exemplary embodiment.

FIG. 7 schematically illustrates a flowchart of a method of the execution of the interaction behavior to acquire the information of the contained object included in the container object.

FIG. 8 schematically illustrates a schematic diagram of the controlled virtual object not performing a search within the container object according to an exemplary embodiment.

FIG. 9 schematically illustrates a schematic diagram of the controlled virtual object performing a search within the container object according to an exemplary embodiment.

FIG. 10 schematically illustrates a schematic diagram of a blurred identifier of a contained object displayed in the container object after the controlled virtual object completes the search within the container object according to an exemplary embodiment.

FIG. 11 schematically illustrates a flowchart of a method for, in response to a first interaction operation performed by the controlled virtual object in the game match interface, controlling an adjustment of the initial interaction parameter to a current interaction parameter according to an exemplary embodiment.

FIG. 12 schematically illustrates a flowchart of a method of the adjustment of the initial interaction parameter to the current interaction parameter according to an exemplary embodiment.

FIG. 13 schematically illustrates a block diagram of a game skill processing apparatus according to an exemplary embodiment.

FIG. 14 schematically illustrates an electronic device for implementing the above method for game skill processing according to an exemplary embodiment.

### DETAILED DESCRIPTION

The exemplary implementation will be described in more detail with reference to the drawings. However, the exemplary implementation can be carried out in various forms and should not be understood as being limited to the examples described herein; rather, these implementations are provided to make the present disclosure more comprehensive and complete and to convey the concept of the exemplary implementation to those skilled in the art. The features, structures, or characteristics described can be combined in any suitable manner in one or more implementations. In the following description, many specific details are provided to give a thorough understanding of the implementation of the present disclosure. However, those skilled in the art will recognize that when the technical solution of the present disclosure is practiced, one or more specific details may be omitted or other methods, components, devices, steps, and the like may be adopted. In other cases, the well-known technical solutions are not elaborately illustrated or described to avoid overshadowing the main points and causing confusion regarding the various aspects of the present disclosure.

Furthermore, the drawings are schematic illustrations and are not drawn to scale. Identical reference numerals in the figures denote identical or similar parts, and thus, repetitive descriptions of them will be omitted. Some of the block diagrams in the drawings represent functional entities, the block diagrams do not correspond to physically or logically separate entities. These functional entities can be implemented in software, or in one or more hardware modules or integrated circuits, or in different networks and/or processor apparatus and/or microcontroller apparatus.

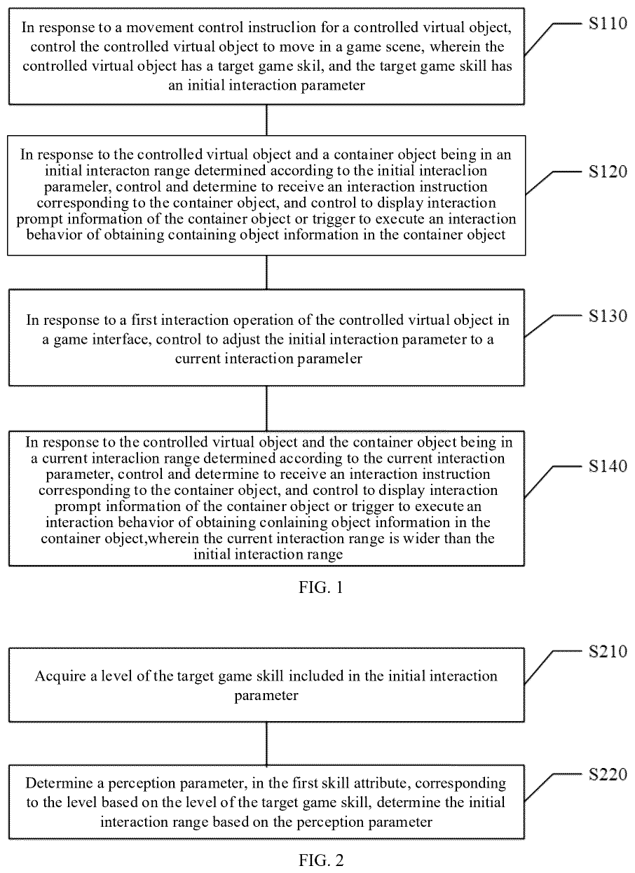

In the present exemplary implementation, a method for game skill processing is provided firstly, the method can be run on a device terminal. The device terminal can include a desktop computer, a portable computer, a smart phone, a tablet computer, or the like. Those skilled in the art can also run the method of the present disclosure on other platforms as needed, and the present exemplary implementation does not make any special limitations thereon. Referring to FIG. 1, the method for game skill processing can include the following steps.

In step S110, in response to the moving control instruction on the controlled virtual object, the controlled virtual object is controlled to move within the game scene, where the controlled virtual object is configured with the target game skill, and the target game skill is configured with the initial interaction parameter.

In step S120, in response to the controlled virtual object and the container object being within the initial interaction range determined based on the initial interaction parameter, the reception of the interaction instruction corresponding to the container object is controlled to be determined, the interaction prompt information of the container object is controlled to be displayed or the execution of the interaction behavior to acquire the information of the contained object included in the container object is triggered.

In step S130, in response to the first interaction operation performed by the controlled virtual object in the game match interface, the initial interaction parameter is controlled to be adjusted to the current interaction parameter.

In step S140, in response to the controlled virtual object and the container object being within the current interaction range determined based on the current interaction parameter, the reception of the interaction instruction corresponding to the container object is controlled to be determined, the interaction prompt information of the container object is controlled to be displayed or the execution of the interaction behavior to acquire the information of the contained object included in the container object is triggered, where the current interaction range is larger than the initial interaction range.

In the above method for game skill processing, in response to the moving control instruction on the controlled virtual object, the controlled virtual object is controlled to move within the game scene, where the controlled virtual object is configured with the target game skill, and the target game skill is configured with the initial interaction parameter; in response to the controlled virtual object and the container object being within the initial interaction range determined based on the initial interaction parameter, the reception of the interaction instruction corresponding to the container object is controlled to be determined, the interaction prompt information of the container object is controlled to be displayed or the execution of the interaction behavior to acquire the information of the contained object included in the container object is triggered; in response to the first interaction operation performed by the controlled virtual object in the game match interface, the initial interaction parameter is controlled to be adjusted to the current interaction parameter; and in response to the controlled virtual object and the container object being within the current interaction range determined based on the current interaction parameter, the reception of the interaction instruction corresponding to the container object is controlled to be determined, the interaction prompt information of the container object is controlled to be displayed or the execution of the interaction behavior to acquire the information of the contained object included in the container object is triggered, where the current interaction range is larger than the initial interaction range. On the one hand, in response to the first interaction operation performed by the controlled virtual object in the game match interface, the initial interaction parameter is controlled to be adjusted to the current interaction parameter; the problem in the related technology that the interaction range between the controlled virtual object and the defeated virtual object remains unchanged is solved, the optimization of the targeted game skill has been achieved, and the interaction experience of the players in the game is enhanced. On the other hand, after the initial interaction parameter is adjusted to the current interaction parameter, in response to the current interaction range between the controlled virtual object and the container object determined based on the current interaction parameter, the interaction prompt information of the container object is controlled to be displayed or the execution of the interaction behavior to acquire the information of the contained object in the container object is triggered based on the current interaction range; the optimization efficiency of the target game skill in the game is improved.

The following provides a detailed explanation and description of each step involved in the method for game skill processing of the present exemplary embodiment.

In step S110, in response to the moving control instruction on the controlled virtual object, the controlled virtual object is controlled to move within the game scene, where the controlled virtual object is configured with the target game skill, and the target game skill is configured with the initial interaction parameter.

In the present exemplary embodiment, after the player enters the game, the moving operation may be performed on the controlled virtual object. When the player performs the moving operation on the controlled virtual object, in response to the moving control instruction on the controlled virtual object, the controlled virtual object is controlled to move within the game scene. The controlled virtual object is configured with the target game skill, where the target game skill can be the looting skill, enabling the controlled virtual object to inspect or retrieve the container object owned by another controlled virtual object. The target game skill is also configured with the initial interaction parameter, where the initial interaction parameter includes the level of the target game skill and the skill effect corresponding to the level of the target game skill.

In the present exemplary embodiment, the target game skill is configured with the first skill attribute and the second skill attribute, where the first skill attribute and the second skill attribute are configured to achieve the skill effect corresponding to the level of the target game skill. When the target game skill is the looting skill, the first skill attribute can be a perception range of the controlled virtual object for the container object; the second skill attribute can be a search time and an inspect time of the controlled virtual object for the container object. When the first skill attribute is the perception range of the controlled virtual object for the container object, the first skill attribute is configured with the perception parameter, and when the level of the target game skill of the controlled virtual object increases, the first skill attribute can be optimized through the perception parameter. When the second skill attribute is the search time of the controlled virtual object for the container object, the second skill attribute is configured with the first interaction response speed parameter, and when the level of the target game skill of the controlled virtual object increases, the search time of the second skill attribute can be optimized through the first interaction response speed parameter. When the second skill attribute is the inspection time of the controlled virtual object for the container object, the second skill attribute is configured with the second interaction response speed parameter, and when the level of the target game skill of the controlled virtual object increases, the inspection time of the second skill attribute can be optimized through the second interaction response speed parameter. In the present exemplary embodiment, the values of the perception parameter, the first interaction response speed parameter, and the second interaction response speed parameter are not specifically limited.

In step S120, in response to the controlled virtual object and the container object being within the initial interaction range determined based on the initial interaction parameter, the reception of the interaction instruction corresponding to the container object is controlled to be determined, the interaction prompt information of the container object is controlled to be displayed or the execution of the interaction behavior to acquire the information of the contained object included in the container object is triggered.

In the present exemplary embodiment, in response to the controlled virtual object and the container object being within the initial interaction range determined based on the level of the target game skill of the controlled virtual object, the reception of the interaction instruction corresponding to the container object is controlled to be determined. In the present exemplary embodiment, the initial interaction range is not specifically limited. For example, when the controlled virtual object moves within the game scene, and the container object appears within the field of view of the controlled virtual object or the controlled virtual object aims at the container object with its crosshair, the interaction instruction is automatically triggered. The container object can be the container in the game scene, such as a fixed supply box in the game scene, a supply box of a defeated controlled virtual object, or a supply box discarded by the controlled virtual object.

In the present exemplary embodiment, referring to FIG. 2, determination of the initial interaction range based on the initial interaction parameter includes the followings.

In step S210, the level of the target game skill included in the initial interaction parameter is acquired.

In step S220, the perception parameter, in the first skill attribute, corresponding to the level is determined based on the level of the target game skill, and the initial interaction range is determined through the perception parameter.

The following provides further explanations and descriptions of steps S210 and S220. Specifically, first, the level of the target game skill included in the initial interaction parameter is acquired; then, the perception parameter, in the first skill attribute, corresponding to the level is determined based on the level of the target game skill; and finally, the initial interaction range is determined through the perception parameter.

When levels of the target game skill are different, the corresponding perception parameters in the first skill attribute are also different. For example, when the game just starts or the level of the target game skill of the controlled virtual object has not reached the first preset level, the perception parameter can be set to 0, that is, when the game just starts or the level of the target game skill of the controlled virtual object has not reached the first preset level, the perception range of the controlled virtual object cannot be optimized. When the level of the target game skill of the controlled virtual object reaches the first preset level, the perception parameter can be set to 10% or 15%. In the present exemplary embodiment, the specific size of the perception parameter is not specifically limited. That is, when the level of the target game skill reaches the first preset level, the perception range of the controlled virtual object for the container object can be controlled to increase.

Furthermore, in the present exemplary embodiment, an application algorithm corresponding to the first skill attribute can also be acquired. When optimizing the first skill attribute, the optimization can be performed through the application algorithm. When the application algorithm corresponding to the first skill attribute is a multiplication algorithm, the perception range=basic perception range*(100%+level of the target game skill*perception parameter). For example, when the level of the target game skill of the controlled virtual object is 5, the basic perception range is 2 meters, and the perception parameter is 10%, then the perception range =2*(100%+0.1*5)=3. That is, when the current level of the target skill is 5, and the virtual object interacts with the items in the interactive container, the perception range of the interactive container expands to 3 meters.

By optimizing the perception range of the controlled virtual object through the perception parameter, the perception range of the controlled virtual object in the game is increased, thereby enhancing the interaction experience of the player in the game.

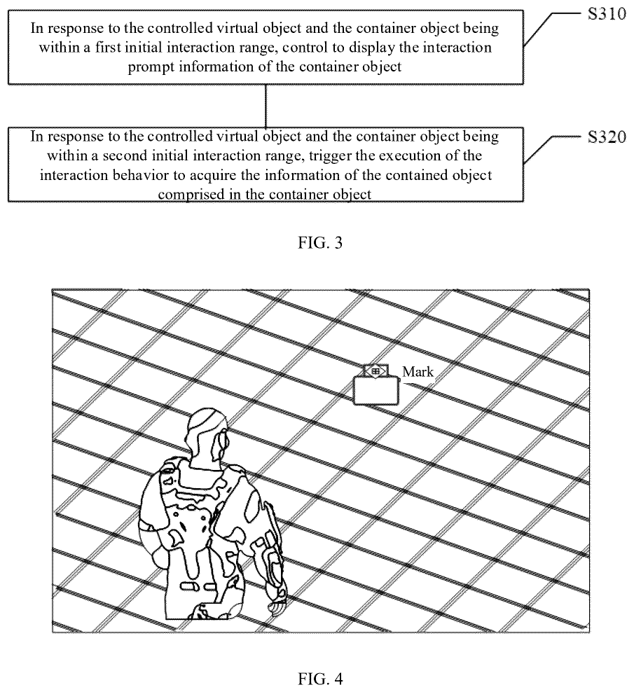

In the present exemplary embodiment, referring to FIG. 3, the interaction range includes the first interaction range and the second interaction range. The interaction prompt information of the container object is controlled to be displayed or the execution of the interaction behavior to acquire the information of the contained object included in the container object is triggered, which may include the followings.

In step S310, in response to the controlled virtual object and the container object being within the first initial interaction range, the interaction prompt information of the container object is controlled to be displayed.

In step S320, in response to the controlled virtual object and the container object being within the second initial interaction range, the execution of the interaction behavior to acquire the information of the contained object included in the container object is triggered.

The following provides further explanations and descriptions of steps S310 and S320. Specifically, the interaction range can include the first interaction range and the second interaction range, that is, the initial interaction range can include the first initial interaction range and the second initial interaction range. When the distance between the controlled virtual object and the container object meets the first interaction range, in response to the controlled virtual object and the container object being within the first interaction range, the interaction prompt information of the container object is controlled to be displayed in the graphical user interface. The interaction prompt information of the container object can be the highlighting of the container object, the outlining of the container object, or the displaying of a list of the container object in the graphical user interface. In the present exemplary embodiment, the interaction prompt information of the container object is not specifically limited. When the distance between the controlled virtual object and the container object meets the second interaction range, in response to the controlled virtual object and the container object being within the second interaction range, the execution of the interaction behavior to acquire the information of the contained object included in the container object is triggered.

In an optional implementation, the first interaction range and the second interaction range are the same.

In another optional implementation, the first interaction range and the second interaction range are different. When referring to the determining of the initial interaction range through the perception parameter, it can be the adjusting of the first interaction range, the adjusting of the second interaction range, or the adjusting of both the first interaction range and the second interaction range in different procedures simultaneously.

Further, in the present exemplary embodiment, the interaction behavior includes the first interaction behavior and the second interaction behavior. The first interaction behavior is configured to trigger the display of the blurred identifier of the contained object corresponding to the information of the contained object included in the container object in the graphical user interface. The second interaction behavior is configured to update the blurred identifier of the contained object to the information identifier of the contained object.

Specifically, when the controlled virtual object and the container object are within the second interaction range, the execution of the first interaction behavior and the second interaction behavior can be triggered. The first interaction behavior is to display the blurred identifier of the contained object corresponding to the information of the contained object included in the container object in the graphical user interface, that is, the first interaction behavior is to search the container object and display the blurred identifier of the contained object included in the container object in the graphical user interface. The second interaction behavior is to inspect the container object and update the blurred identifier of the contained object to the information identifier of the contained object.

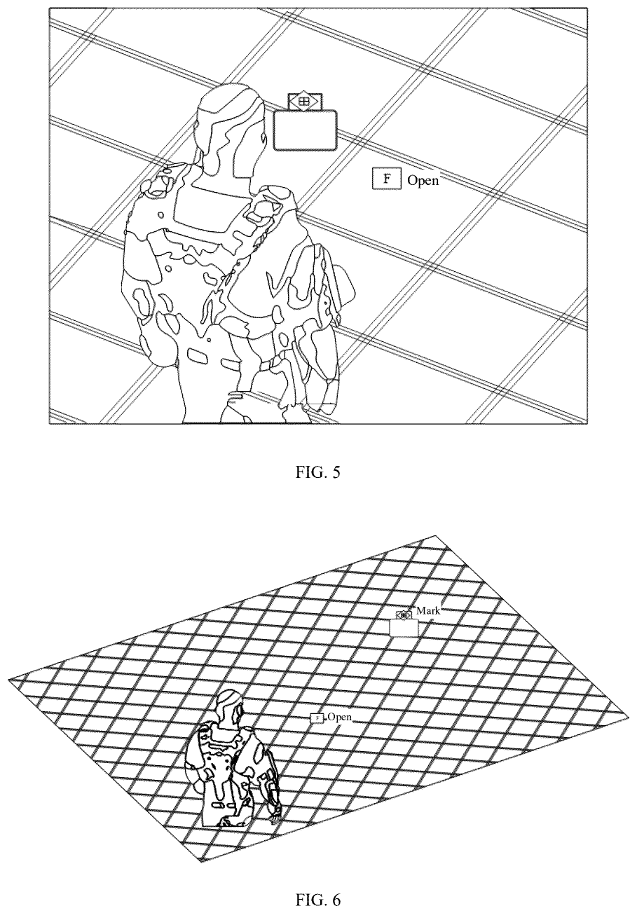

FIG. 4 shows the schematic diagram of the controlled virtual object in the game scene. FIG. 5 shows the schematic diagram of the controlled virtual object and the container object being within the first interaction range. FIG. 6 shows the schematic diagram showing an expansion of the first interaction range as the level of the target game skill of the controlled virtual object increases.

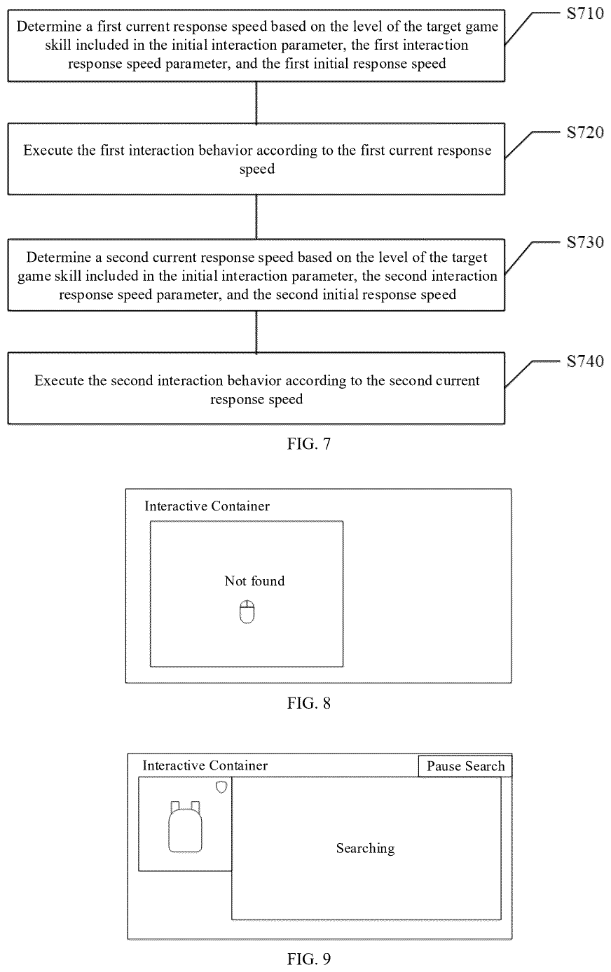

Further, the first interaction behavior is configured with the first initial response speed, and the second interaction behavior is configured with the second initial response speed. Referring to FIG. 7, the execution of the interaction behavior to acquire the information of the contained object included in the container object can include the followings.

In step S710, the first current response speed is determined based on the level of the target game skill included in the initial interaction parameter, the first interaction response speed parameter, and the first initial response speed.

In step S720, the first interaction behavior is executed by using the first current response speed.

In step S730, the second current response speed is determined based on the level of the target game skill included in the initial interaction parameter, the second interaction response speed parameter, and the second initial response speed.

In step S740. the second interaction behavior is executed by using the second current response speed.

The following provides further explanations and descriptions of steps S710 to S740. Specifically, the first interaction behavior is configured with the first initial response speed, and the second interaction behavior is configured with the second initial response speed. In the present exemplary embodiment, the first initial response speed and the second initial response speed are not specifically limited. For the first interaction behavior, the second skill attribute is configured with the first interaction response speed. When the first interaction behavior is executed, the first current response speed can be determined based on the level of the target game skill, the first interaction response speed parameter, and the first initial response speed. When the second interaction behavior is executed, the second current response speed can be determined based on the level of the target game skill, the second interaction response speed parameter, and the second initial response speed.

When the first current response speed and the second current response speed are calculated, the application algorithms corresponding to the first interaction behavior and the application algorithm corresponding to the second interaction behavior can also be acquired. When the application algorithms corresponding to the first interaction behavior and the second interaction behavior are multiplication algorithms, the first current response speed=the first initial response speed+the level of the target game skill*the first interaction response speed parameter; and the second current response speed=the second initial response speed+the level of the target game skill*the second interaction response speed parameter.

When the controlled virtual object performs the first interaction behavior, that is, when the controlled virtual object searches the container object, the information of the contained object included in the container object cannot be directly displayed after the interactive object is opened, and a search is required. The search takes a certain amount of time. After the search is completed, the blurred identifier of the contained object is displayed. When the blurred identifier of the contained object is inspected, the blurred identifier of the contained object is updated to the information identifier of the contained object. To optimize the second skill attribute, as the level of the target game skill of the controlled virtual object increases, the first interaction response speed parameter and the second interaction response speed parameter can be set to negative numbers to reduce the search time and inspection time. In the present exemplary embodiment, the values of the first interaction response speed parameter and the second interaction response speed parameter are not specifically limited.

It should be noted that as the level of the target game skill of the controlled virtual object increases, when the level of the target game skill reaches the second preset level and the controlled virtual object performs the first interaction behavior, the search time of the first interaction behavior can be set to 0. That is, when the level of the target game skill reaches the second preset level, the first interaction response parameter is set to −1, and the application algorithm for the first interaction behavior is modified to the multiplication algorithm. Then, the first current response speed=the first initial response speed*(100%+the first interaction response speed parameter)^ the level of the target game skill.

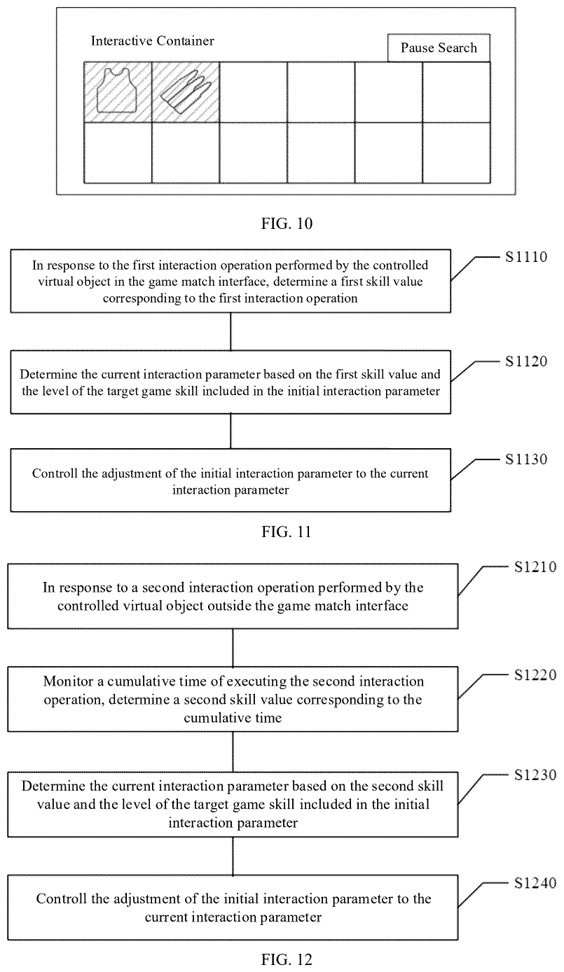

FIG. 8 shows the schematic diagram of the controlled virtual object not performing the search within the container object, FIG. 9 shows the schematic diagram of the controlled virtual object performing the search within the container object, and FIG. 10 shows the schematic diagram of the blurred identifier of the contained object displayed in the container object after the controlled virtual object completes the search within the container object.

When the first interaction behavior is executed, that is, when the controlled virtual object searches the container object in the game scene and inspects the contained object included in the container object, the container object will cover the game scene where the virtual object is located. It takes a certain amount of search time to search for the contained object included in the container object. During the search, the virtual object cannot observe the game scene. It also takes a certain amount of inspect time to inspect the contained object. When inspecting, different contained objects will have corresponding sound effects, increasing the risk of the controlled virtual object in the game scene and prolonging a restricted time of the controlled virtual object. By optimizing the execution time of the first interaction behavior and the second interaction behavior through the first interaction response speed parameter and the second interaction response speed parameter, the restricted time of the controlled virtual object when interacting with the container object is reduced.

In step S130, in response to the first interaction operation performed by the controlled virtual object in the game match interface, the initial interaction parameter is controlled to be adjusted to the current interaction parameter.

The first interaction operation performed by the controlled virtual object can be the search, within the container object, performed by the controlled virtual object in the game match interface. Referring to FIG. 11, in response to the first interaction operation performed by the controlled virtual object in the game match interface, the initial interaction parameter is controlled to be adjusted to the current interaction parameter, which can include the followings.

In step S1110, in response to the first interaction operation performed by the controlled virtual object in the game match interface, the first skill value corresponding to the first interaction operation is determined.

In step S1120, the current interaction parameter is determined based on the first skill value and the level of the target game skill included in the initial interaction parameter.

In step S1130, the initial interaction parameter is controlled to be adjusted to the current interaction parameter.

The following provides further explanations and descriptions of steps S1110 to S1130. Specifically, in response to the first interaction operation performed by the controlled virtual object in the game match interface, the first skill value corresponding to the first interaction operation is determined; then, the current interaction parameter is determined based on the first skill value and the level of the target game skill included in the initial interaction parameters; after acquiring the current interaction parameter, the initial interaction parameter is controlled to be adjusted to the current interaction parameter.

In the present exemplary embodiment, in addition to updating the initial interaction parameter of the controlled virtual object through the first interaction operation in the game match interface, the controlled virtual object can also update the initial interaction parameter through the second interaction operation outside the game match interface. Referring to FIG. 12, the initial interaction parameter is controlled to be adjusted to the current interaction parameter, which can include the followings.

In Step s1210, the second interaction operation performed by the controlled virtual object outside the game match interface is responded to.

In Step s1220, the cumulative time of executing the second interaction operation is monitored, and the second skill value corresponding to the cumulative time is determined.

In Step s1230, the current interaction parameter is determined based on the second skill value and the level of the target game skill included in the initial interaction parameter.

In Step s1240, the initial interaction parameter is controlled to be adjusted to the current interaction parameter.

The following provides further explanations and descriptions of steps S1210 to S1240. Specifically, in response to the second interaction operation performed by the controlled virtual object outside the game match interface, the cumulative time of executing the second interaction operation outside the game match interface is monitored. The second skill value corresponding to the cumulative time is determined based on the cumulative time, that is, the cumulative time can be converted into the second skill value. During the conversion, a 1:1 conversion or a 2:1 conversion can be adopted. In the present exemplary embodiment, no specific limitation is imposed thereto. After acquiring the second skill value, the current interaction parameter can be determined based on the second skill value and the level of the target game skill. After acquiring the current interaction parameter, the initial interaction parameter is controlled to be adjusted to the current interaction parameter. In the present exemplary embodiment, when the experience value of the target game skill of the controlled virtual object reaches the experience value required for upgrading the target game skill, the level of the target game skill can be determined based on the experience value. In the present exemplary embodiment, the experience value required for upgrading the target game skill is not specifically limited.

In step S140, in response to the controlled virtual object and the container object being within the current interaction range determined based on the current interaction parameter, the reception of the interaction instruction corresponding to the container object is controlled to be determined, the interaction prompt information of the container object is controlled to be displayed or the execution of the interaction behavior to acquire the information of the contained object included in the container object is triggered, where the current interaction range is larger than the initial interaction range.

In the present exemplary embodiment, after the initial interaction parameter of the controlled virtual object is updated to the current interaction parameter, in response to the controlled virtual object and the container object being within the current interaction range determined based on the current interaction parameter, that is, in response to the controlled virtual object and the container object being within the current interaction range determined based on the current level of the target game skill and the perception parameter, when the current level of the target game skill is increased, the current interaction range determined by the current level is larger than the initial interaction range. The current interaction range includes the first current interaction range and the second current interaction range. When the controlled virtual object and the contained object are within the first current interaction range, the interaction prompt information of the container object is displayed in the graphical user interface. When the controlled virtual object and the contained object are within the second current interaction range, the execution of the interaction behavior to acquire the information of the contained object included in the container object is triggered.

The method for game skill processing according to some exemplary embodiments of the present disclosure has at least the following advantages. On the one hand, after the game starts, the first interaction operation performed by the controlled virtual object in the game match interface and the second interaction operation performed by the controlled virtual object outside the game match interface can be monitored, and the initial interaction parameter of the controlled virtual object can be updated based on the first interaction operation or the second interaction operation. The ways to determine the interaction parameter of the controlled virtual object are enriched and the efficiency of determining the current level of the target game skill of the controlled virtual object is improved. On the other hand, after the level of the target game skill of the controlled virtual object is increased, the perception range of the controlled virtual object can be optimized based on the perception parameter. When the controlled virtual object and the container object are within the second interaction range, the search time of the controlled virtual object for the container object can be optimized based on the first interaction response speed, and the inspect time of the controlled virtual object for the contained object included in the container object can be optimized based on the second interaction response speed. The restricted time of the controlled virtual object in the game is reduced, the interaction experience of the user in the game is enhanced, and the optimization efficiency of the target game skill in the game is improved.

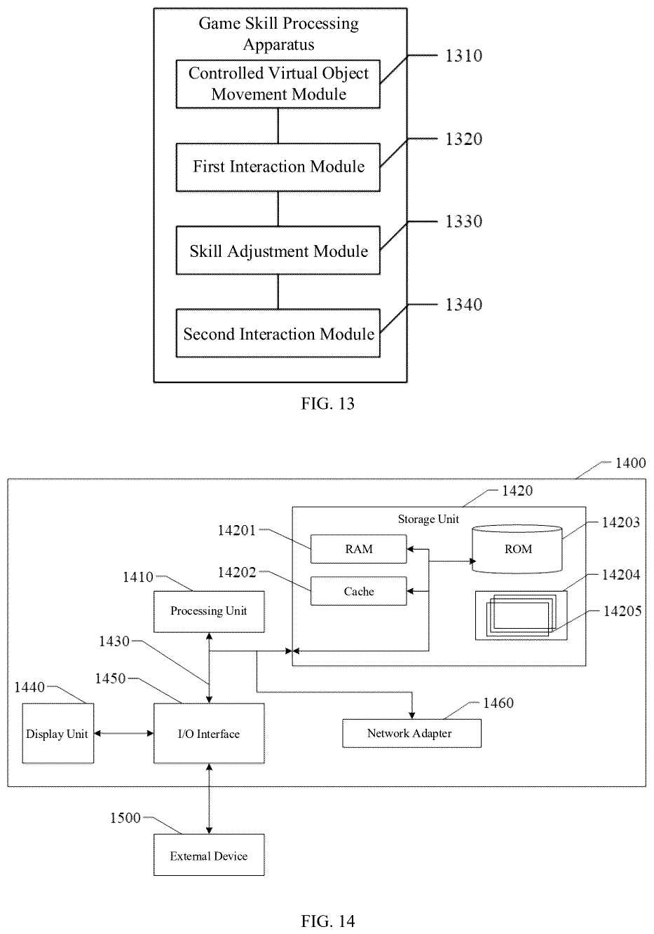

The exemplary embodiment of the present disclosure further provides a game skill processing apparatus, referring to FIG. 13, which may include: the controlled virtual object movement module 1310, the first interaction module 1320, the skill adjustment module 1330, and the second interaction module 1340.

The controlled virtual object movement module 1310 is configured to control, in response to the moving control instruction on the controlled virtual object, the controlled virtual object to move within the game scene, where the controlled virtual object is configured with the target game skill, the target game skill is configured with the initial interaction parameter.

The first interaction module 1320 is configured to control, in response to the controlled virtual object and the container object being within the initial interaction range determined based on the initial interaction parameter, to determine the reception of the interaction instruction corresponding to the container object, display the interaction prompt information of the container object or trigger the execution of the interaction behavior to acquire the information of the contained object included in the container object.

The skill adjustment module 1330 is configured to control, in response to the first interaction operation performed by the controlled virtual object in the game match interface, to adjust the initial interaction parameter to the current interaction parameter.

The second interaction module 1340 is configured to control, in response to the controlled virtual object and the container object being within the current interaction range determined based on the current interaction parameter, to determine the reception of the interaction instruction corresponding to the container object, display the interaction prompt information of the container object or trigger the execution of the interaction behavior to acquire the information of the contained object included in the container object, where the current interaction range is larger than the initial interaction range.

With respect to the specific details of each module in the above-mentioned game skill processing apparatus, the corresponding method for game skill processing can be referred to, which will not be elaborated here.

In an exemplary embodiment of the present disclosure, the target game skill is configured with the first skill attribute and the second skill attribute. The first skill attribute is configured with the perception parameter. The second skill attribute is configured with the first interaction response speed parameter and the second interaction response speed parameter.

In an exemplary embodiment of the present disclosure, determination of the initial interaction range based on the initial interaction parameter includes the followings.

The level of the target game skill included in the initial interaction parameter is acquired.

The perception parameter, in the first skill attribute, corresponding to the level is determined based on the level of the target game skill, and the initial interaction range is determined through the perception parameter.

In an exemplary embodiment of the present disclosure, the interaction range includes the first interaction range and the second interaction range. When referring to that the interaction prompt information of the container object is controlled to be displayed or the execution of the interaction behavior to acquire the information of the contained object included in the container object is triggered, it may include the followings.

In response to the controlled virtual object and the container object being within the first initial interaction range, the interaction prompt information of the container object is controlled to be displayed.

In response to the controlled virtual object and the container object being within the second initial interaction range, the execution of the interaction behavior to acquire the information of the contained object included in the container object is triggered.

In an exemplary embodiment of the present disclosure, the interaction behavior includes the first interaction behavior and the second interaction behavior. The first interaction behavior is configured to trigger the display of the blurred identifier of the contained object corresponding to the information of the contained object included in the container object in the graphical user interface. The second interaction behavior is configured to update the blurred identifier of the contained object to the information identifier of the contained object.

In an exemplary embodiment of the present disclosure, the first interaction behavior is configured with the first initial response speed, and the second interaction behavior is configured with the second initial response speed.

The execution of the interaction behavior to acquire the information of the contained object included in the container object can include the followings.

The first current response speed is determined based on the level of the target game skill included in the initial interaction parameter, the first interaction response speed parameter, and the first initial response speed.

The first interaction behavior is executed by using the first current response speed.

The second current response speed is determined based on the level of the target game skill included in the initial interaction parameter, the second interaction response speed parameter, and the second initial response speed.

The second interaction behavior is executed by using the second current response speed.

In an exemplary embodiment of the present disclosure, when referring to that in response to the first interaction operation performed by the controlled virtual object in the game match interface, the initial interaction parameter is controlled to be adjusted to the current interaction parameter, it can include the followings.

In response to the first interaction operation performed by the controlled virtual object in the game match interface, the first skill value corresponding to the first interaction operation is determined.

The current interaction parameter is determined based on the first skill value and the level of the target game skill included in the initial interaction parameter.

The initial interaction parameter is controlled to be adjusted to the current interaction parameter.

In an exemplary embodiment of the present disclosure, when referring to that the initial interaction parameter is controlled to be adjusted to the current interaction parameter, it can include the followings

The second interaction operation performed by the controlled virtual object outside the game match interface is responded to.

The cumulative time of executing the second interaction operation is monitored, and the second skill value corresponding to the cumulative time is determined.

The current interaction parameter is determined based on the second skill value and the level of the target game skill included in the initial interaction parameter.

The initial interaction parameter is controlled to be adjusted to the current interaction parameter.

It should be noted that although several modules or units for action execution are mentioned in the detailed description above, such division is not mandatory. In fact, according to the embodiments of the present disclosure, the features and functions of two or more modules or units described above can be embodied in one module or unit. Conversely, the features and functions of one module or unit described above can be embodied in multiple modules or units further divided.

Furthermore, although the steps of the method according to the present disclosure are described in a specific order in the attached figures, this does not imply or require that these steps must be executed in this specific order or that all the shown steps must be executed to achieve the desired result. Additionally, certain steps can be omitted, multiple steps can be combined into one step for execution, and/or one step can be divided into multiple steps for execution, and the like.

In an exemplary embodiment of the present disclosure, an electronic device capable of implementing the above method is also provided.

Those skilled in the art can understand that various aspects of the present disclosure can be implemented as systems, methods, or program products. Therefore, various aspects of the present disclosure can be embodied in the form of: a complete hardware implementation, a complete software implementation (including firmware, microcode, and the like), or a combination implementation of hardware and software aspects, which can be collectively referred to as “circuits”, “modules”, or “systems”.

The electronic device 1400 according to an implementation of the present disclosure is described below with reference to FIG. 14. The electronic device 1400 shown in FIG. 14 is merely an example and should not impose any limitations on the functions and application scope of the embodiments of the present disclosure.

Referring to FIG. 14, the electronic device 1400 is presented in the form of a general computing device. The components of the electronic device 1400 can include, but are not limited to: at least one processing unit 1410, at least one storage unit 1420, a bus 1430 for connecting different system components (including the storage unit 1420 and the processing unit 1410), and a display unit 1440.

The storage unit stores a program code, and the program code can be executed by the processing unit 1410, so that the processing unit 1410 performs the steps described in the section of method examples above according to various exemplary embodiments of the present disclosure. For example, the processing unit 1410 can perform the steps S110 as shown in FIG. 1: in response to a moving control instruction on the controlled virtual object, the controlled virtual object is controlled to move within the game scene, where the controlled virtual object is configured with the target game skill, and the target game skill is configured with the initial interaction parameter; in Step S120: in response to the controlled virtual object and the container object being within the initial interaction range determined based on the initial interaction parameter, the reception of the interaction instruction corresponding to the container object is controlled to be determined, the interaction prompt information of the container object is controlled to be displayed or the execution of the interaction behavior to acquire the information of the contained object included in the container object is triggered; in step S130: in response to the first interaction operation performed by the controlled virtual object in the game match interface, the initial interaction parameter is controlled to be adjusted to the current interaction parameter; and in step S140: in response to the controlled virtual object and the container object being within the current interaction range determined based on the current interaction parameter, the reception of the interaction instruction corresponding to the container object is controlled to be determined, the interaction prompt information of the container object is controlled to be displayed or the execution of the interaction behavior to acquire the information of the contained object included in the container object is triggered, where the current interaction range is larger than the initial interaction range.

The storage unit 1420 may include a readable medium in the form of a volatile storage unit, such as a random-access memory (RAM) 14201 and/or a cache 14202, and may further include a read-only memory (ROM) 14203.

The storage unit 1420 may also include a program/utility 14204 with a set (at least one) of program modules 14205, where such program modules 14205 include but not limited to: an operating system, one or more applications, other program modules and program data, each of which or any combination of which may include the implementation of a network environment.

The bus 1430 may represent one or more of several types of bus structures, including a storage unit bus or a storage unit controller, a peripheral bus, a graphics acceleration port, a processing unit or local bus using any of several bus structures.

The electronic device 1400 may also communicate with one or more external devices 1500 (such as a keyboard, a pointing device, a Bluetooth device, and the like) and may communicate with one or more devices that enable the user to interact with the electronic device 1400, and/or with any device that enables the electronic device 1400 to communicate with one or more other computing devices (such as a router, modem, and the like). Such communication may be carried out through an input/output (I/O) interface 1450. Moreover, the electronic device 1400 may also communicate with one or more networks (such as a local area network (LAN), a wide area network (WAN), and/or a public network, such as the Internet) through a network adapter 1460. As shown in the figure, the network adapter 1460 communicates with other modules of the electronic device 1400 through the bus 1430. It should be understood that although not shown in the figure, other hardware and/or software modules may be used in conjunction with the electronic device 1400, including but not limited to: a microcode, a device driver, a redundant processing unit, an external disk drive array, a RAID system, a tape drive, and a data backup storage system, and the like.

Through the description of the above implementations, it is easy for those skilled in the art to understand that the exemplary implementations described herein can be implemented through software or through a combination of software and necessary hardware. Therefore, the technical solutions according to the implementations of the present disclosure can be embodied as a software product, which can be stored in a non-volatile storage medium (such as a CD-ROM, a USB flash drive, a mobile hard disk, and the like) or on a network. The software product includes several instructions to cause a computing device (such as a personal computer, server, terminal device, or network device, etc.) to perform the methods according to the implementations of the present disclosure.

In the exemplary embodiments of the present disclosure, a computer-readable storage medium is also provided. The computer-readable storage medium stores a program product capable of implementing the above methods in the specification. In some implementations, various aspects of the present disclosure may also be implemented in the form of a program product, which includes a program code. When the program product is run on the terminal device, the program code is used to cause the terminal device to perform the steps described in the section of method examples above according to various exemplary implementations of the present disclosure.

The program product for implementing the above-mentioned method according to the implementations of the present disclosure can be embodied in a portable compact disc read-only memory (CD-ROM) and include the program code, and can be run on the terminal device, such as a personal computer. However, the program product of the present disclosure is not limited to this. In this document, the readable storage medium can be any tangible medium that contains or stores a program that can be used by or in conjunction with an instruction execution system, an apparatus or a component.

The program product can adopt any combination of one or more readable medium. The readable medium can be a readable signal medium or a readable storage medium. The readable storage medium, for example, can be but is not limited to the system, the apparatus or the component of electrical, magnetic, optical, electromagnetic, infrared, or semiconductor, or any combination of the above. More specific examples of the readable storage medium (non-exhaustive list) include: an electrical connection with one or more wires, a portable disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

The computer-readable signal medium can include data signals transmitted in a baseband or as part of a carrier wave, which carry the readable program code. Such transmitted data signals can take any form, including but not limited to an electromagnetic signal, an optical signal, or any suitable combination of the above. The readable signal medium can also be any readable medium other than the readable storage medium that can transmit, propagate or transport the program for use by or in connection with an instruction execution system, apparatus or component.

The program code contained on the readable medium can be transmitted in any appropriate medium, including but not limited to a wireless medium, a wired medium, an optical fiber, a RF, and the like, or any suitable combination of the above.

The program code for performing the operations of the present disclosure can be written in any combination of one or more programming languages. The programming languages include object-oriented programming languages such as Java, C++, and also include conventional procedural programming languages such as “C” language or similar programming languages. The program code can be executed entirely on a computing device of the user, partially on a device of the user, as an independent software package, partially on a computing device of the user and partially on a remote computing device, or entirely on the remote computing device or a server. In the case of involving the remote computing device, the remote computing device can be connected to the computing device of the user or can be connected to the external computing device (for example, using an Internet service provider to connect through the Internet) through any type of network, including the local area network (LAN) or the wide area network (WAN).

In addition, the above-mentioned figures are only schematic illustrations of the processing included in the method according to the exemplary embodiments of the present disclosure, and are not for limiting purposes. It is easy to understand that the processing shown in the above-mentioned figures does not indicate or limit the time sequence of these processes. Also, it is easy to understand that these processes can be executed, for example, synchronously or asynchronously in multiple modules.

It will be readily apparent to those skilled in the art that other embodiments of the present disclosure can be easily conceived after considering the specification and practicing the invention disclosed herein. The present disclosure is intended to cover any variations, uses or adaptations of the present disclosure that follow the general principles of the present disclosure and include common knowledge or conventional techniques in the technical field of the present disclosure that are not disclosed herein. The description and examples are only considered as exemplary, and the true scope and spirit of the present disclosure are indicated by the claims.

1.-10. (cancelled)

11. A method for processing a graphical user interface (GUI), comprising:
in response to a moving instruction on a virtual object, controlling the virtual object to move within the GUI, wherein the GUI is provided through a terminal device and configured to display a game match interface, the virtual object and a container object are displayed in the game match interface, the virtual object is configured with a game skill, and the game skill is configured with an first parameter;
in response to the virtual object and the container object being within a first range determined based on the first parameter, displaying interaction information of the container object;
in response to a first interaction operation performed by the virtual object, controlling an adjustment of the first parameter to a second parameter; and
in response to the virtual object and the container object being within a second range determined based on the second parameter, displaying the interaction information of the container object, wherein the second range is larger than the first range.

12. The method according to claim 11, further comprising:
acquiring a level of the game skill comprised in the first parameter; and
determining the first range according to the level.

13. The method according to claim 12, further comprising:
enlarging the first range in response to the level of the game skill being increased.

14. The method according to claim 11, wherein in response to the virtual object and the container object being within the first range, displaying the interaction information of the container object comprises:
in response to the virtual object and the container object being within a first interaction range, displaying prompt information of the container object; and
in response to the virtual object and the container object being within a second interaction range, displaying execution of an interaction behavior for acquiring information of a contained object comprised in the container object,
wherein the first interaction range and the second interaction range are equal to or within the first range.

15. The method according to claim 14, wherein displaying execution of the interaction behavior comprises:
acquiring a level of the game skill comprised in the first parameter; and
displaying, according to a response speed corresponding to the level, the execution of the interaction behavior.

16. The method according to claim 15, further comprising:
improving the response speed in response to the level of the game skill being increased.

17. The method according to claim 14, wherein displaying the prompt information of the container object comprises at least one of:
highlighting the container object;
displaying the container object by highlighting outline of the container object; or
displaying a list of the container object.

18. The method according to claim 11, wherein displaying the interaction information of the container object comprises:
displaying execution of a first interaction behavior configured to trigger displaying of a blurred identifier of a contained object comprised in the container object, and
displaying execution of a second interaction behavior configured to update the blurred identifier to an information identifier of the contained object.

19. The method according to claim 18, wherein the game skill is further configured with a first speed parameter and a second speed parameter; the first interaction behavior is configured with a first initial speed, the second interaction behavior is configured with a second initial speed; and
displaying the interaction information of the container object comprises:
determining a first current speed based on a level of the game skill comprised in the first parameter, the first speed parameter, and the first initial speed;
displaying execution of the first interaction behavior according to the first current speed;
determining a second current speed based on the level of the game skill, the second speed parameter, and the second initial speed; and
displaying execution of the second interaction behavior according to the second current speed.

20. The method according to claim 19, wherein
determining the first current speed comprises determining the first current speed as a sum of the first initial speed and a product of the level of the game skill and the first speed parameter; or
determining the second current speed comprises determining the second current speed as a sum of the second initial speed and a product of the level of the game skill and the second speed parameter.

21. The method according to claim 11, wherein displaying the interaction information of the container object comprises:
in response to a search operation triggered by the virtual object on the container object, displaying a search procedure of the container object;
in response to completion of the search procedure, displaying a blurred identifier of a contained object comprised in the container object;
in response to an inspect operation triggered by the virtual object on the blurred identifier, displaying an inspect procedure of the contained object; and
in response to completion of the inspect procedure, displaying an information identifier of the contained object.

22. The method according to claim 21, further comprising:
acquiring a level of the game skill; and
performing, according to a speed corresponding to the level, displaying of at least one of the search procedure or the inspect procedure.

23. The method according to claim 22, further comprising:
improving the speed in response to the level of the game skill being increased.

24. The method according to claim 11, further comprising:
determining a first skill value corresponding to the first interaction operation; and
determining the second parameter based on the first skill value and a level of the game skill comprised in the first parameter.

25. The method according to claim 11, further comprising:
in response to a second interaction operation performed by the virtual object outside the game match interface, monitoring a cumulative time of executing the second interaction operation;
determining a second skill value corresponding to the cumulative time; and
determining the second parameter based on the second skill value and a level of the game skill comprised in the first parameter.

26. An electronic device, comprising:
a processor; and
a memory configured to store an executable instruction of the processor;
wherein the processor, upon executing the executable instruction, is configured to:
in response to a moving instruction on a virtual object, control the virtual object to move within a graphical user interface (GUI), wherein the GUI is provided through the electronic device and configured to display a game match interface, the virtual object and a container object are displayed in the game match interface, the virtual object is configured with a game skill, and the game skill is configured with an first parameter;
in response to the virtual object and the container object being within a first range determined based on the first parameter, display interaction information of the container object;
in response to a first interaction operation performed by the virtual object, control an adjustment of the first parameter to a second parameter; and
in response to the virtual object and the container object being within a second range determined based on the second parameter, display the interaction information of the container object, wherein the second range is larger than the first range.

27. The device according to claim 26, wherein the processor is further configured to:
acquire a level of the game skill comprised in the first parameter; and
determine the first range according to the level.

28. The device according to claim 26, wherein the processor is specifically configured to:
in response to the virtual object and the container object being within a first interaction range, display prompt information of the container object; and
in response to the virtual object and the container object being within a second interaction range, display execution of an interaction behavior for acquiring information of a contained object comprised in the container object,
wherein the first interaction range and the second interaction range are equal to or within the first range.

29. The device according to claim 26, wherein the processor is specifically configured to:
display execution of a first interaction behavior configured to trigger displaying of a blurred identifier of a contained object comprised in the container object, and
display execution of a second interaction behavior configured to update the blurred identifier to an information identifier of the contained object.

30. A non-transitory computer storage medium storing a computer program, wherein the computer program, upon being executed by a processor of a terminal device, is used for implementing a method for processing a graphical user interface (GUI), and the method comprises:
in response to a moving instruction on a virtual object, controlling the virtual object to move within the GUI, wherein the GUI is provided through the terminal device and configured to display a game match interface, the virtual object and a container object are displayed in the game match interface, the virtual object is configured with a game skill, and the game skill is configured with an first parameter;
in response to the virtual object and the container object being within a first range determined based on the first parameter, displaying interaction information of the container object;
in response to a first interaction operation performed by the virtual object, controlling an adjustment of the first parameter to a second parameter; and
in response to the virtual object and the container object being within a second range determined based on the second parameter, displaying the interaction information of the container object, wherein the second range is larger than the first range.
